(19) United States
(12) Patent Application Publication
(10) Pub. No.: US 2026/0130819 A1
(43) Pub. Date: May 14, 2026

(54) MASSAGER

(71) Applicant: Dongguan Mengma Electronic Technology Co., Ltd., Dongguan City (CN)

(72) Inventor: Dongtao Zhou, Dongguan City (CN)

(21) Appl. No.: 19/442,718

(22) Filed: Jan. 7, 2026

(30) Foreign Application Priority Data
Jul. 4, 2025 (CN) 202521408213.8

(51) Int. Cl. A61H 19/00; A61H 23/02

(52) U.S. Cl. CPC A61H 19/44; A61H 23/0254; A61H 2201/1215; A61H 2201/1628; A61H 2201/165; A61H 2205/087

(57) ABSTRACT

A massager comprising an elastic carrier, a vibration mechanism, and fastening straps. The carrier includes a main body and a protrusion. The protrusion is disposed protruding from the back side of the main body, and the vibration mechanism is disposed inside a cavity of the main body, adjacent to the protrusion. The vibration mechanism is configured to drive the protrusion to vibrate. A plurality of straps are connected to the carrier. In use, the elastic carrier is secured to the body via the straps, and the vibration mechanism drives the protrusion to massage a corresponding body part.

### TECHNICAL FIELD

The present invention relates to the field of massage devices, and in particular to a massager.

### BACKGROUND

Pleasure massagers are commonly used tools in daily life. Conventional vibratory massagers are typically handheld and placed against a sensitive area, such as the vagina, to provide stimulation to the corresponding part of the body via vibration. A drawback is the requirement for manual operation during use, which is inconvenient. Improvements are therefore desirable.

### SUMMARY

To address at least one of the above technical deficiencies, the present invention provides the following technical solution:
The present application discloses a massager, comprising: an elastic carrier, a vibration mechanism, and fastening straps. The carrier includes a main body and a protrusion. The protrusion is disposed protruding from the back side of the main body, and a vibration mechanism is disposed inside a cavity of the main body, adjacent to the protrusion. The vibration mechanism is configured to drive the protrusion to vibrate. A plurality of straps are connected to the elastic carrier.

In use, for example, the elastic carrier is secured to the body via the straps, and the vibration mechanism drives the protrusion to massage a corresponding part of the body, thereby providing greater convenience.

Regarding the number of straps, it can be selected as needed, such as a single strap or a plurality of straps. The carrier may be secured to the body through a method like wrapping or binding.

Further, at least one strap is connected to each of the top end and the bottom end of the carrier, facilitating the securement of the carrier to a corresponding position on the body.

Further, one strap is connected to the top end of the carrier, and two straps are respectively connected to two lateral sides of the bottom end of the carrier, facilitating the securement of the carrier to a corresponding position on the body.

Further, a waistband is also included. Ends of the straps are connected to the waistband. The waistband may be, for example, a common belt used for fastening trousers. Preferably, the waistband is annular in shape. The straps and the carrier together form a connecting band, with leg openings for wearing formed between sides of the connecting band and corresponding portions of the waistband. In this configuration, the massager resembles panties. In use, for example, the massager may be worn directly as panties, with the carrier contacting the vaginal area of a female user. The vibration mechanism drives the protrusion to vibrate, simultaneously massaging the corresponding position of the vagina.

Further, each strap comprises a first strap segment, a second strap segment, and a connector ring. The first strap segment is connected to the second strap segment via the connector ring, facilitating assembly and formation.

Further, the main body is sheet-like. The protrusion comprises a first columnar portion and a second columnar portion. A bottom end of the first columnar portion is connected to the corresponding main body via the second columnar portion. Peripheral walls of the first columnar portion and the second columnar portion are curved surfaces. The top end of the first columnar portion is a convex surface. The diameter of the first columnar portion is greater than the diameter of the second columnar portion. The sheet-like main body conforms more easily to the human body. Defining the configuration of the protrusion helps improve stability and comfort during massage.

Further, a control mechanism is included. The control mechanism comprises a mounting base, a control circuit board, and a battery. The control circuit board is disposed on the mounting base. The battery is disposed inside the mounting base. The battery and the vibration mechanism are connected to the control circuit board, such that the control circuit board controls the activation and deactivation of the vibration mechanism. A switch key on the control circuit board is located at a correspondingly provided cavity opening on the carrier.

Further, a press plate is included. The press plate is disposed above the switch key and is connected to a wall of the cavity opening or to the mounting base. Applying force to the press plate causes the switch key to move. The press plate may be made of an elastic material; applying force deforms the press plate to contact the switch key. Alternatively, the press plate may be slidably connected to the mounting base; applying force moves the press plate to correspondingly contact the switch key.

Further, the vibration mechanism comprises a drive motor, a casing, and a rotatable member. The rotatable member is mounted on an output shaft of the drive motor. The drive motor and the rotatable member are both housed inside a cavity of the casing.

Compared to the prior art, the advantages of the present invention are as follows:
The structure of the massager in the present invention facilitates the securement of the carrier to a corresponding position on the body, eliminating the need for manual holding, and making massage more convenient.

### BRIEF DESCRIPTION OF THE DRAWINGS

In order to more clearly illustrate the technical solutions in the embodiments of the present invention, a brief introduction to the accompanying drawings required for describing the embodiments will be provided below. Obviously, the drawings in the following description are merely some embodiments of the present invention. For those of ordinary skill in the art, other drawings may be derived from these drawings without creative effort.

FIG. 1 is an overall structural view of the massager according to Embodiment 1 of the present invention;

FIG. 2 is another overall structural view of the massager according to Embodiment 1 of the present invention;

FIG. 3 is a cross-sectional structural view of the massager according to Embodiment 1 of the present invention.

Reference numerals: 1: carrier; 2: strap; 3: waistband; 4: control mechanism; 5: vibration mechanism; 6: press plate; 10: main body; 11: protrusion; 12: cavity opening; 20: connector ring; 21: first strap segment; 22: second strap segment; 40: mounting base; 41: battery; 42: control circuit board; 43: switch key; 50: casing; 51: drive motor; 52: rotatable member; 110: second columnar portion; 111: first columnar portion; 112: convex surface

### DESCRIPTION OF THE EMBODIMENTS

An embodiment of the present invention will now be described in detail with reference to the accompanying drawings.

### Embodiment 1

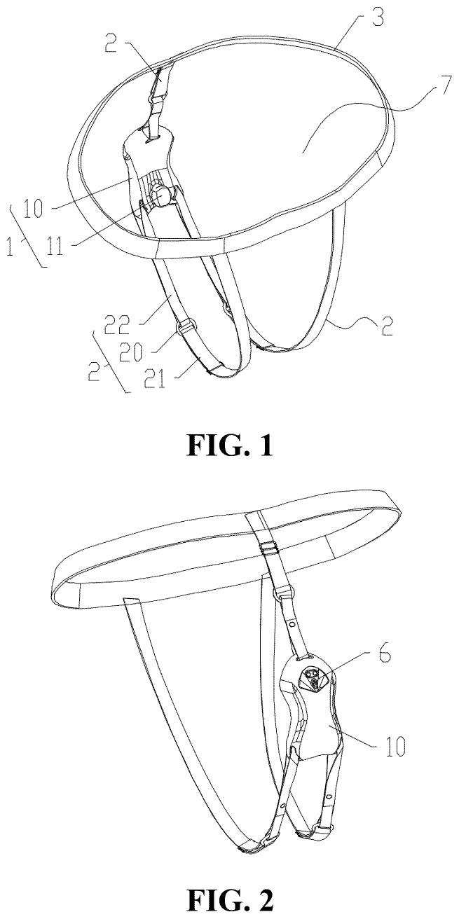

As shown in FIGS. 1, 2, and 3, the massager according to this embodiment comprises an elastic carrier 1, a vibration mechanism 5, and fastening straps 2. The carrier 1 includes a main body 10 and a protrusion 11. The shape of the main body 10 may be selected as needed, preferably a sheet-like configuration, which can better conform to the body. The protrusion 11 is disposed protruding from the back side of the main body 10. As shown in FIG. 1, the protrusion 11 is preferably located on a lower portion of the back side of the main body 10, allowing it to more stably abut against a corresponding sensitive area (e.g., vagina, clitoris, etc.) of a female user during use. The specific shape of the protrusion 11 is as follows: the protrusion 11 includes a first columnar portion 111 and a second columnar portion 110. The top end of the second columnar portion 110 is connected to the bottom end of the first columnar portion 111, and the bottom end of the second columnar portion 110 is connected to the corresponding main body 10. The peripheral walls of the first columnar portion 111 and the second columnar portion 110 are curved surfaces. For example, both the first columnar portion 111 and the second columnar portion 110 may be elliptical cylindrical in shape. The top end of the first columnar portion 111 is a convex surface 112. The multi-curved surface design helps improve comfort when contacting the human body. The diameter of the first columnar portion 111 is greater than that of the second columnar portion 110. This design helps improve stability and massage comfort when the protrusion 11 contacts and performs massage to a corresponding sensitive part of the user. The main body 10 and the protrusion 11 are preferably integrally formed by injection molding, such as from silicone material, or they may be formed separately and subsequently fixed together.

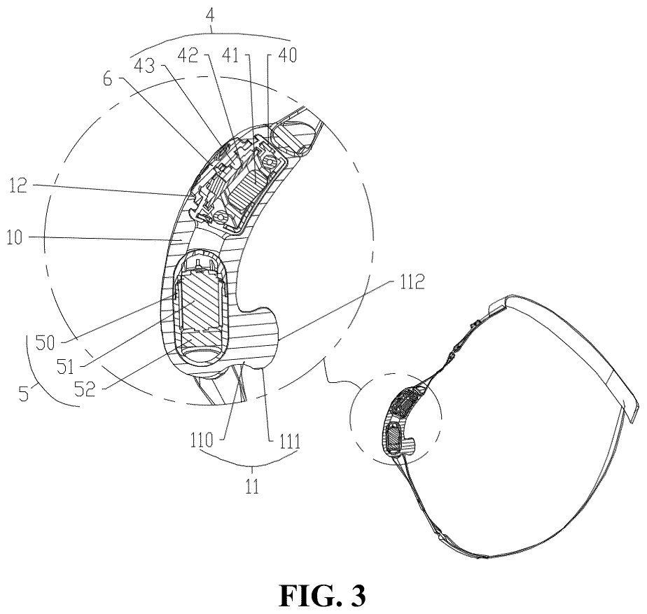

In this embodiment, the vibration mechanism 5 is installed inside the cavity of the main body 10, adjacent to the protrusion 11. The vibration mechanism 5 drives the protrusion 11 to vibrate, simultaneously vibrating the sensitive body part contacted by the protrusion 11. As for the vibration mechanism 5, it may be similar to common vibrating eggs, and the structure shown in FIG. 3 may be selected. Specifically, the vibration mechanism 5 includes a drive motor 51, a casing 50, and a rotatable member 52. The rotatable member 52 is mounted on the output shaft of the drive motor 51. The rotatable member 52 may be, for example, oval-shaped or eccentric. Both the drive motor 51 and the rotatable member 52 are housed inside the cavity of the casing 50. The drive motor 51 drives the rotatable member 52 to rotate, and during rotation, the rotatable member 52 impacts the casing 50 to generate vibration.

In this embodiment, straps 2 are provided. A plurality of straps 2 are connected to the elastic carrier 1. For example, ends of the straps 2 are connected to the top end, bottom end, or lateral sides of the main body 10 of the carrier 1. The number of straps 2 may be selected as needed, such as a single strap or a plurality of straps. Preferably, as shown in FIG. 1, there are three straps 2: one strap 2 is connected to the top end of the main body 10 of the carrier 1, and the other two straps 2 are connected to the two lateral sides of the bottom end of the main body 10 of the carrier 1, respectively.

In this embodiment, a waistband 3 is provided. The ends of the straps 2 are connected to the waistband 3. The waistband 3 may be, for example, a common belt used for fastening trousers. Preferably, the waistband 3 is directly preformed into an annular shape. The ends of the straps 2 connected to the top end of the main body 10 and the ends of the straps 2 connected to the bottom end of the main body 10 are connected to opposite positions on the waistband 3, respectively, as shown in FIG. 1. In this configuration, the massager resembles panties. The straps 2 and the carrier 1 together form a connecting band, and leg openings 7 for wearing are formed between the sides of the connecting band and the corresponding portions of the waistband 3. For example, by pre-setting the length of the straps 2 and the position of the carrier 1, the massager can be worn directly as panties during use, correspondingly bringing the carrier 1 into contact with sensitive areas (e.g., the vaginal area), which is convenient.

As for the straps 2, they may be common strips. Preferably, a segmented assembly structure is adopted. Specifically, for example, each strap 2 comprises a first strap segment 21, a second strap segment 22, and a connector ring 20. After the first strap segment 21 and the second strap segment 22 are respectively connected to the main body 10 of the carrier 1 and the waistband 3, the first strap segment 21 and the second strap segment 22 are connected via the connector ring 20. For example, an end of the first strap segment 21 passes through the connector ring 20, is looped back, and is fixed to an intermediate portion of itself by means such as stitching. The second strap segment 22 is similarly configured. This structure facilitates assembly and formation.

For ease of control, a control mechanism 4 is provided in this embodiment. For example, the control mechanism 4 includes a mounting base 40, a control circuit board 42, and a battery 41. The control circuit board 42 is mounted on the mounting base 40. The battery 41 is housed inside the mounting base 40. The battery 41 and the drive motor 51 of the vibration mechanism 5 are connected to the control circuit board 42. The battery 41 supplies power, and the control circuit board 42 is connected to the vibration mechanism 5 to control its activation and deactivation. A switch key 43 on the control circuit board 42 is located at a cavity opening 12 correspondingly formed on the front surface of the main body 10 of the carrier 1 for convenient pressing control. The connection structure between the control circuit board 42, the battery 41, etc., and the mounting base 40 may refer to conventional techniques and will not be elaborated here.

In this embodiment, a press plate 6 is provided. The press plate 6 is disposed above the switch key 43 and is connected to a wall of the cavity opening or to the mounting base 40. Applying force to the press plate 6 causes the switch key 43 to move. The press plate 6 may be made of an elastic material; applying force deforms the press plate 6 to contact the switch key 43. Alternatively, the press plate 6 may be slidably connected to the mounting base 40; applying force moves the press plate 6 to correspondingly contact the switch key 43. Preferably, the press plate 6 is pre-formed with a mark indicating the switch for easy identification.

The foregoing are merely preferred embodiments of the present invention, and the scope of the present invention is not limited thereto. Any technical solution under the inventive concept of the present invention shall fall within the protection scope of the present invention. It should be noted that several modifications and refinements made by those of ordinary skill in the art without departing from the principle of the present invention shall also be considered within the protection scope of the present invention.

What is claimed is:

1. A massager comprising:
an elastic carrier, a vibration mechanism, and fastening straps;
wherein the carrier includes a main body and a protrusion, the protrusion being disposed protruding from the back side of the main body;
wherein the vibration mechanism is disposed inside a cavity of the main body, adjacent to the protrusion, and is configured to drive the protrusion to vibrate; and
wherein a plurality of straps are connected to the carrier.

2. The massager according to claim 1, wherein at least one strap is connected to each of a top end and a bottom end of the carrier.

3. The massager according to claim 2, wherein one strap is connected to the top end of the carrier, and two straps are respectively connected to two lateral sides of the bottom end of the carrier.

4. The massager according to claim 3, further comprising a waistband, wherein ends of the straps are connected to the waistband.

5. The massager according to claim 4, wherein the waistband is annular in shape, the straps and the carrier collectively form a connecting band, with leg openings for wearing formed between sides of the connecting band and corresponding portions of the waistband.

6. The massager according to claim 2, wherein each strap comprises a first strap segment, a second strap segment, and a connector ring, the first strap segment being connected to the second strap segment via the connector ring.

7. The massager according to claim 1, wherein the main body is sheet-like;
wherein the protrusion comprises a first columnar portion and a second columnar portion, a bottom end of the first columnar portion being connected to the corresponding main body via the second columnar portion;
wherein peripheral walls of the first columnar portion and the second columnar portion are curved surfaces;
wherein the top end of the first columnar portion is a convex surface; and
wherein the diameter of the first columnar portion is greater than the diameter of the second columnar portion.

8. The massager according to claim 1, further comprising a control mechanism, the control mechanism comprising a mounting base, a control circuit board, and a battery;
wherein the control circuit board is disposed on the mounting base; the battery is disposed inside the mounting base; the battery and the vibration mechanism are electrically connected to the control circuit board, whereby the control circuit board controls activation and deactivation of the vibration mechanism; and
wherein a switch key on the control circuit board is accessible through a cavity opening correspondingly formed on the carrier.

9. The massager according to claim 8, further comprising a press plate disposed above the switch key and connected to a wall of the cavity opening or to the mounting base, wherein applying force to the press plate causes the switch key to be actuated.

10. The massager according to claim 1, wherein the vibration mechanism comprises a drive motor, a casing, and a rotatable member, the rotatable member being mounted on an output shaft of the drive motor, and the drive motor and the rotatable member being housed inside a cavity of the casing.
